(19) United States
(12) Patent Application Publication
(10) Pub. No.: US 2010/0305903 A1
(43) Pub. Date: Dec. 2, 2010

(54) Tea Timer And Method Of Calculating Steep Tim

(76) Inventor: Richard Sharpe, Woodridge, IL (US)

Correspondence Address: LATHROP & GAGE LLP, 4845 PEARL EAST CIRCLE, SUITE 201, BOULDER, CO, 80301, US

(21) Appl. No.: 12/787,666

(22) Filed: May 26, 2010

Related U.S. Application Data
(60) Provisional application No. 61/181,220, filed on May 26, 2009.

(51) Int. Cl. A47J 31/44; G04F 10/00

(52) U.S. Cl. 702/176; 99/285

(57) ABSTRACT

A tea timer for determining a tea steeping time and optionally a tea steeping temperature is described. The tea timer includes a temperature measuring component, for example, a thermometer or thermistor enabled probe, for measuring temperature of a fluid and a control body having a display and circuitry. The display displays at least the determined tea steeping time. The circuitry determines the tea steeping time according to a measured fluid temperature, a user selected tea type and one or both of a tea strength and a brew type.

### RELATED APPLICATIONS

This application claims priority of U.S. Provisional Patent Application No. 61/181,220, filed May 26, 2009 and incorporated herein by reference.

### BACKGROUND

Tea lovers recognize that proper brewing is essential to a good cup of tea. Left to steep for too long, some teas (e.g., black or green tea) over infuse and become bitter. Too little steeping time results in a weak tea. A problem with preparing a perfect cup of tea is knowing the appropriate steeping time and temperature for each tea or tea type. Adding the varied steeping methods, for example using a tea ball, tea bag or loose tea, further increases the complexity of preparing a perfect cup of tea. It is obvious that the desire to enjoy a perfectly brewed cup of tea is prevalent in today's society, but finding the time to acquire the specialized knowledge to perfectly brew each tea or tea type is incompatible with many people's busy lives, especially when a person consumes a wide variety of teas.

### SUMMARY OF THE INVENTION

In an embodiment, a tea timer includes a temperature measuring component for measuring temperature of a fluid, and a control body with circuitry for determining tea steeping time according to fluid temperature measured by the temperature measuring component.

In another embodiment, a tea timer includes a temperature measuring component for measuring temperature of a fluid, a user interface for entering a tea type and one or both of a tea strength and brew type, and a microcontroller for calculating tea steeping time according to fluid temperature measured by the temperature measuring component, tea type and tea strength and/or brew type. A timer counts down the calculated tea steeping time, and an alarm signals when the calculated tea steeping time has elapsed.

In another embodiment, a method for determining tea steeping time includes accepting a tea type via a user interface, measuring temperature of a fluid for brewing tea, accepting one or both of a tea strength and a brew type via the user interface, and processing the tea type with the fluid temperature and one or both of the tea strength and brew type, to determine tea steeping time.

The disclosed tea timer automatically determines steep time based on a strength setting, tea type, temperature of the water, and brewing/steeping method. It is for example designed for a single serving ratio of a teaspoon of tea per 8 oz. cup. Generally, a standard tea bag contains one teaspoon of tea. The disclosed timer may be used in teacups, mugs, and teapots, and may be integrated into teacups, mugs, and teapots. The tea timer also indicates time left to brew.

### BRIEF DESCRIPTION OF THE DRAWINGS

FIG. 1A is a schematic front view of an exemplary tea timer, according to an embodiment.

FIG. 1B illustrates an exemplary scrollable list for the tea timer of FIG. 1A.

FIG. 1C shows an exemplary user selectable display configuration for the tea timer of FIG. 1A.

FIG. 2 is another front view of the tea timer of FIG. 1.

FIG. 3A shows exemplary tea type abbreviations viewable on the tea timer of FIGS. 1 and 2.

FIG. 3B shows an exemplary 16 segment display for conveying information on a display of the tea timer of FIGS. 1 and 2.

FIG. 4A shows additional features of the tea timer of FIGS. 1 and 2, according to an embodiment.

FIG. 4B shows another exemplary scrollable list for a tea timer display, according to an embodiment.

FIG. 4C shows options for conveying time and temperature on a tea timer display, according to an embodiment.

FIG. 5 is a flow chart illustrating one exemplary method for calculating steep time.

FIG. 6 is a flowchart showing a subroutine in the method of FIG. 5.

FIG. 7 is a block diagram illustrating electronics and connections of a tea timer, according to an embodiment.

FIG. 8 is a flow chart illustrating exemplary processing logic for a tea timer, according to an embodiment.

FIG. 9A is a side view of a holder for supporting the tea timer of FIG. 1 in a fluid vessel.

FIG. 9B is a top view of the holder of FIG. 9A.

FIG. 9C shows the holder of FIG. 9A supporting the tea timer of FIG. 1.

### DETAILED DESCRIPTION

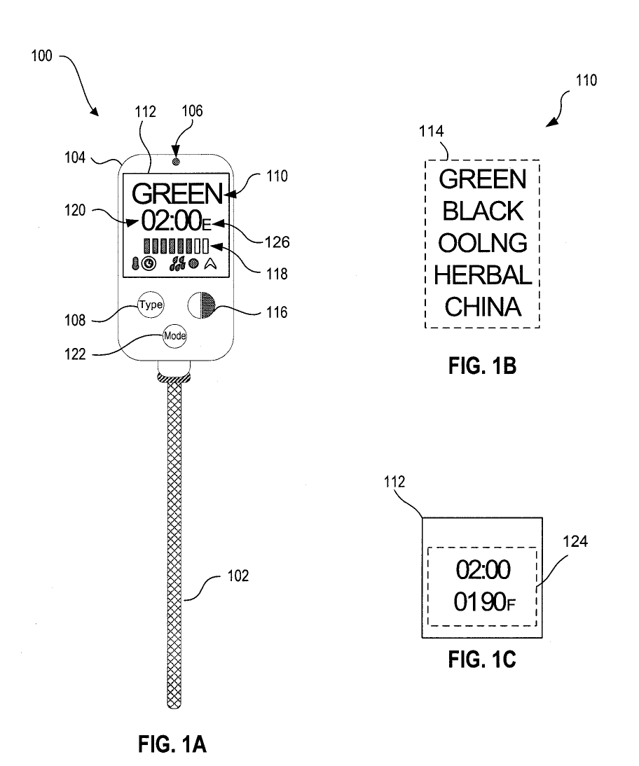

FIG. 1A schematically shows a tea timer 100. FIG. 1B shows a scrollable list of tea types that are selectable using inputs to tea timer 100. FIG. 1C shows one optional screen for a display of tea timer 100. FIGS. 1A-1C are best viewed together in combination with the following description.

Timer 100 includes a probe 102 connected to a control body 104. Probe 102 may include a temperature measuring component, selected from the group including a thermometer, an infrared thermometer, and a thermistor. Probe 102 may include a weight or be fabricated of a material such that its weight counter balances the weight of control body 104. Alternatively, timer 100 may be otherwise counter-balanced such that timer 100 does not tip out of a cup, for example a small teacup. Control body 104 includes a brew indicator 106, a display 112 and three buttons: a tea type button 108, a strength button 116, and a mode button 122.

In one embodiment, brew indicator 106 is an LED that is illuminated by circuitry of control body 104 in response to a temperature increase detected by probe 102. Brew indicator 106 illuminates to indicate that tea is brewing.

A tea type button 108 facilitates selection of a type of tea to be brewed (e.g., green tea, black tea, chai tea, herbal tea, etc.). In one example of operation, pressing type button 108 initiates display of a tea type or series of tea types on a tea type display area 110 of display 112. In another example of operation, pressing tea type button 108 brings up a scrollable menu 114, FIG. 1B, of tea types on tea type display area 110. In another example of operation, each press of tea type button 108 displays a next tea type in a series of possible selections, on tea type display area 110. In FIG. 1, tea type display area 110 indicates green tea. Menu 114 shows indicators for green, black, oolong, herbal and china tea types. In another example of operation, choosing a tea type from menu 114 selects a tea type category, which brings up a sub-menu of specific teas belonging to the selected tea type category. For example, selecting tea type category “Black” may bring up a sub-menu of specific teas including Assam, Ceylon, Darjeeling, etc. However, timer 100 may operate by selecting a tea type category, rather than a specific tea. For example, Darjeeling may be brewed by selecting tea type category “Black” without having to select Darjeeling from a specific tea sub-menu. Table 1, below, is an exemplary listing of specific teas belonging to the types shown in menu 114. Table 1 also lists exemplary flavors that may be blended in black, green, white, herbal or rooibos teas, and which may be selected to further customize brewing time according to tea characteristics.

TABLE 1
Teas by Type

BLACK
assam
ceylon
darjeeling
earl grey bravo
english breakfast
golden monkey
olden needle
irish breakfast
keemun
lapsang souchong
mambo
yunnan
BLACK EXOTICA
golden harvest
red mudan
yunnan coungou
namring first flush 2001
sungma first flush
OOLONG
dragon phoenix pearl
formosa oolong
jade oolong
jasmine
jasmine yin hau
pouchong
ti kuan yin
wuyi ensemble
OOONG EXOTICA
black pearl
feng huang oolong
jasmine snow
kuei hua se chubng
lichee pearl
ROOIBOS
rooibos
rooibos berry
rooibos lemon
rooibos mango
rooibos melon
rooibos mint & chocolate
rooibos orange
rooibos peach
rooibos tropics
rooibos vanilla
GREEN
casablanca twist
citron green
dragonwell
genmai cha
ginseng green
gunpowder
gyokuro
li zi xiang
mandarin green
pi lo chun
sencha
white monkey
yunnan green
GREEN EXOTICA
ding gu
green mudan
green pyramid
gui hua
huang hua
huang shan
huo shan
jade zeppelin
jin xian
jin zhu
long xu
lu an
plum blossom
qi shan
rolling clouds
rose mu dan
silver sprout
tai ping
yong xi
yue xi
HERBAL
apple cantata
berry blast
blood orange
chamomile
chamomile
dewy cherry
foxtrot
fruit medly
peppermint
pina colada
spicy lemon
WHITE
silver needle
snowbud
song yang yin hou
white darjeeling
white peony
ying hao organic
DECAF
decaf ceylon
decaf grey
decaf citron green
decaf lemon
decaf mandarin green
decaf mango
decaf peach
decaf raspberry
decaf strawberry
decaf vanilla
FLAVORS
almond
apple
banana
caramel
cherry
chocolate
Christmas
cinnamon
coconut
cream
currant
forest berries
ginger
lemon
mango
melon
orange
oriental spice
passionfruit
peach
pineapple
raspberry
rum
strawberry
valentines
vanilla
OTHER
nuts
bottled teas

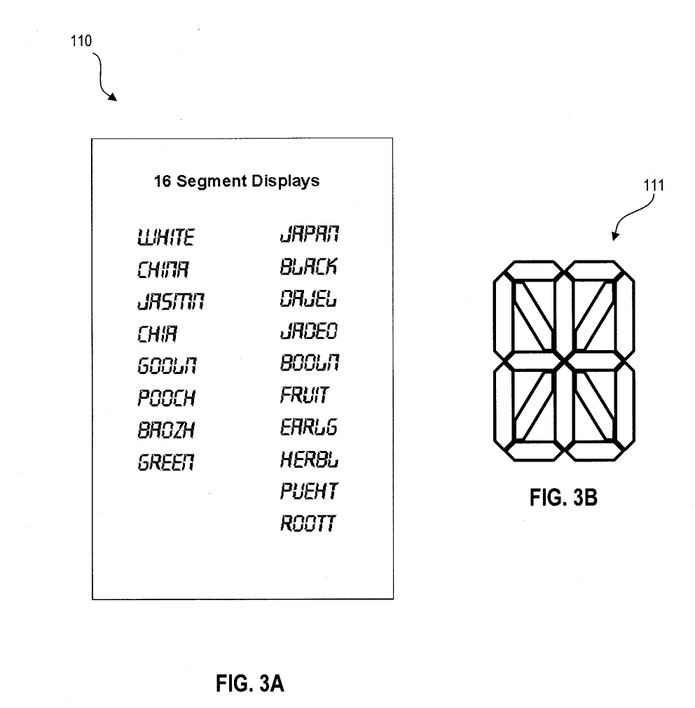

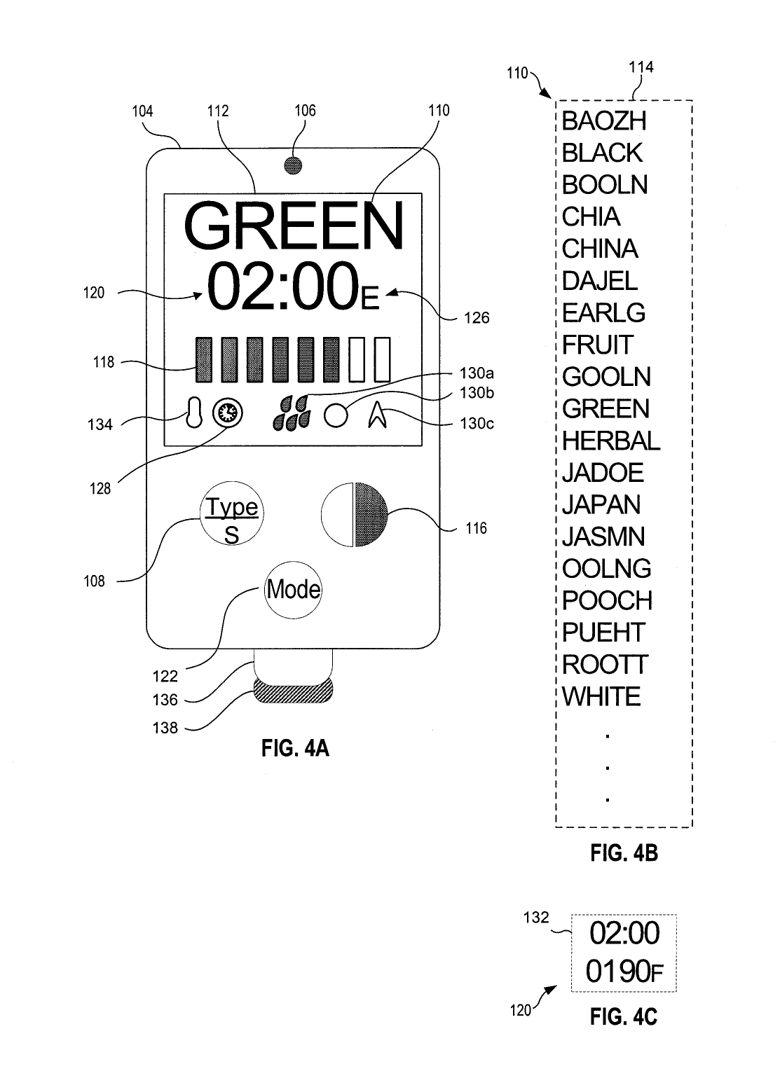

In one example of operation, tea type button 108 is pressed and held down to select a displayed tea type. Tea type button 108 may also be pressed to turn timer 100 on, thereby acting as a start button, with a subsequent press or presses used to select tea type. It will be appreciated that the tea types shown in FIG. 1 are exemplary. Additional tea types may be displayed on tea type display area 110, including, but not limited to those shown in FIGS. 3 and 4 and Table 1.

Strength button 116 allows selection of a strength of brewed tea. Tea strength is for example indicated by strength indicator icons 118. In the example of FIG. 1, strength icon 118 includes 8 bars, but may include more or fewer bars without departing from the scope hereof. Optionally, strength icon 118 is a numerical display indicating, for example, a percentage strength. Strength icon 118 is shown in FIG. 1 as a series of bars that “fill” as stronger tea is selected, e.g., via multiple pushes of button 116 or by holding down button 116 until the desired strength is indicated by strength icon 118. In an embodiment, strength button 116 is a split button (in effect, two buttons) having a strength increase side and a strength decrease side. Pressing the strength increase side of button 116 “fills” additional bars of strength indicator 118, indicating a stronger brewed tea, and pressing the strength decrease side of button 116 “empties” bars of strength indicator 118, indicating a weaker brewed tea.

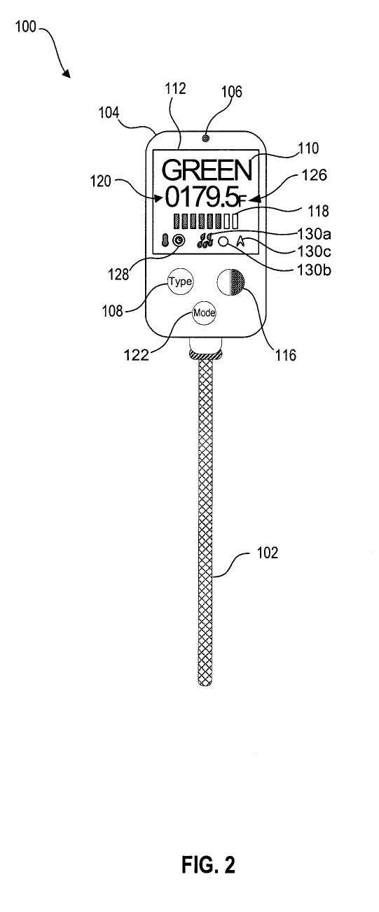

A temperature/time display area 120 shows an amount of brewing time elapsed or remaining, and/or the temperature sensed by probe 102. Pressing mode button 122 for example switches between display of time remaining and display of current temperature within display area 120. Alternately, pressing mode button 122 enlarges display area 120 relative to display 112, to temporarily show both temperature and time as pop-up 124 (FIG. 1C). A C/F icon 126 indicates whether the temperature displayed at display area 120 is measured in degrees Celsius or Fahrenheit. In one example of operation, selection of the Centigrade/Fahrenheit scale is made by pressing mode button 122 until the desired temperature scale is shown at C/F icon 126, and then pressing type button 108 to confirm the desired scale. As further described with respect to FIG. 2, mode button 122 also facilitates selection of a brew type (such as loose tea, a tea ball or a tea bag).

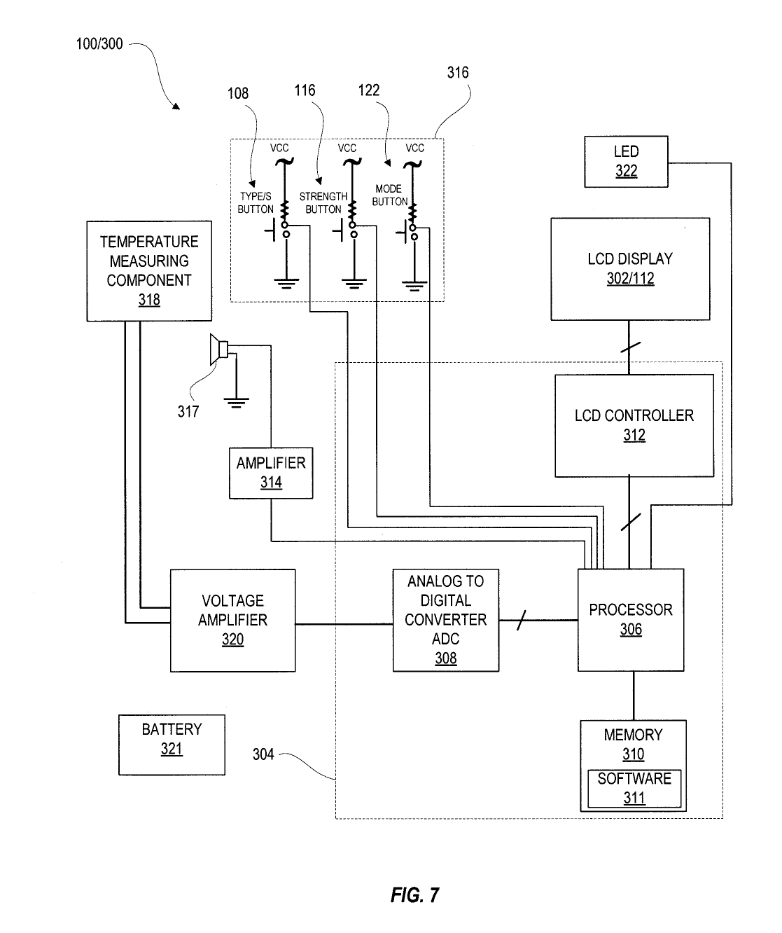

In an alternate embodiment, temperature is measured by a non-contact infrared (IR) sensor and probe 102 is not included. In this embodiment, tea timer 100 is formed as a lid or cover or has appendages for suspending the timer above the brewing tea such that no part of the tea timer is in physical contact with the liquid. The IR sensor measures the IR energy emitted by the liquid, producing data which is processible (e.g., by processor 506, FIG. 7) into a temperature measurement. In an embodiment, where timer 100 is formed as a lid or cover, tea timer 100 may act as a thermal insulator to reduce heat loss from the brewing tea, maintaining a more constant liquid temperature.

In FIG. 2, temperature/time display area 120 indicates a water/tea temperature of 179.5° F. as measured by probe 102. Temperature is displayed in degrees Fahrenheit, as indicated by C/F icon 126. Green tea is selected and shown at display area 110. Strength indicator icon 118 indicates a relatively strong tea—six of eight strength bars are filled. Where eight strength bars are provided, each bar may represent a 12.5% increase in tea strength. A clock icon 128 graphically indicates that brew/steep timing is underway. Clock icon 128 may automatically turn on when timing is started, for example, by pressing type button 108. Mode button 122 may be used to select from brew type icons 130a-130c on display 112, according to brewing method/type. Brew type icon 130a represents brewing with loose tea, icon 130b represents brewing with a tea ball, and icon 130c represents brewing with a tea bag (including traditional and make-your-own tea bags). In the example of FIG. 2, loose tea icon 130a is shown as “filled”, indicating that loose tea is selected. Tea ball icon 130b and tea bag icon 130c are not “filled” and therefore not selected.

Circuitry of timer 100 (e.g., a processor 506, FIG. 7) determines appropriate brew time based upon strength selection, tea type, water temperature and brew type. Timer 100 counts down the time remaining until proper brewing is achieved, and may display remaining time at time/temperature display area 120. A user for example toggles between remaining time and current temperature measured by probe 102, by pressing mode button 122. Optionally, timer 100 alternates between displaying remaining time and current temperature. For example, timer 100 displays remaining time for 3 seconds and then displays temperature for 2 seconds, and repeats. Calculations within timer 100 are for example based upon a tea-to-liquid ratio of one teaspoon of tea per eight oz. of liquid (i.e., water). Table 2, below, shows exemplary steep time calculations.

TABLE 2
Steep Time Calculations

| TEA TYPE | S Temp | STF | T Factor | BT | Level 1 | Level 2 | Level 3 | Level 4 | Level 5 | Level 6 | Level 7 | Level 8 |
|---|---|---|---|---|---|---|---|---|---|---|---|---|
| Baozhong | 170 | 340 | 0.8019 | 1 | 34.1 | 68.2 | 102.2 | 136.3 | 170.4 | 204.5 | 238.6 | 272.6 |
| Black | 212 | 400 | 1.0000 | 1 | 50.0 | 100.0 | 150.0 | 200.0 | 250.0 | 300.0 | 350.0 | 400.0 |
| Black Oolong | 195 | 500 | 0.9198 | 1 | 57.5 | 115.0 | 172.5 | 230.0 | 287.4 | 344.9 | 402.4 | 459.9 |
| Chia | 212 | 300 | 1 | 1 | 37.5 | 75.0 | 112.5 | 150.0 | 187.5 | 225.0 | 262.5 | 300.0 |
| China | 180 | 200 | 0.8491 | 1 | 21.2 | 42.5 | 63.7 | 84.9 | 106.1 | 127.4 | 148.6 | 169.8 |
| Darjeeling | 212 | 400 | 1.0000 | 1 | 50.0 | 100.0 | 150.0 | 200.0 | 250.0 | 300.0 | 350.0 | 400.0 |
| Earl Grey | 212 | 500 | 1.0000 | 1 | 62.5 | 125.0 | 187.5 | 250.0 | 312.5 | 375.0 | 437.5 | 500.0 |
| Fruit | 212 | 500 | 1.0000 | 1 | 62.5 | 125.0 | 187.5 | 250.0 | 312.5 | 375.0 | 437.5 | 500.0 |
| Green | 170 | 380 | 0.8019 | 1 | 38.1 | 76.2 | 114.3 | 152.4 | 190.4 | 228.5 | 266.6 | 304.7 |
| Green Oolong | 170 | 300 | 0.8019 | 1 | 30.1 | 60.1 | 90.2 | 120.3 | 150.4 | 180.4 | 210.5 | 240.6 |
| Herbal | 212 | 600 | 1.0000 | 1 | 75.0 | 150.0 | 225.0 | 300.0 | 375.0 | 450.0 | 525.0 | 600.0 |
| Jade Oolong | 212 | 480 | 1.0000 | 1 | 60.0 | 120.0 | 180.0 | 240.0 | 300.0 | 360.0 | 420.0 | 480.0 |
| Japanese | 170 | 380 | 0.8019 | 1 | 38.1 | 76.2 | 114.3 | 152.4 | 190.4 | 228.5 | 266.6 | 304.7 |
| Jasmine | 180 | 285 | 0.8491 | 1 | 30.2 | 60.5 | 90.7 | 121.0 | 151.2 | 181.5 | 211.7 | 242.0 |
| Poochung | 170 | 300 | 0.8019 | 1 | 30.1 | 60.1 | 90.2 | 120.3 | 150.4 | 180.4 | 210.5 | 240.6 |
| Puerh | 212 | 600 | 1.0000 | 1 | 75.0 | 150.0 | 225.0 | 300.0 | 375.0 | 450.0 | 525.0 | 600.0 |
| Root Tea | 212 | 1800 | 1.0000 | 1 | 225.0 | 450.0 | 675.0 | 900.0 | 1125.0 | 1350.0 | 1575.0 | 1800.0 |
| White | 165 | 200 | 0.7783 | 1 | 19.5 | 38.9 | 58.4 | 77.8 | 97.3 | 116.7 | 136.2 | 155.7 |

STF = Maximum number of seconds recommended for Level 8 strength.
Level 1 = ⅛ Level 8 based on steep Temp
Recommend level is 4 in all cases
Level 1 is 12.5% of Level 8
T Factor = Steep Temp (S Temp)/212
Brew Types:
Loose = 1
Ball = 1.4
Tea Bag = 1.5

In one aspect, a visual or audible alarm signals the end of a calculated brewing time. For example, brew indicator 106 illuminates or, if already illuminated, brew indicator 106 blinks or flashes. Tea timer 100 may include an audible alarm (not shown) such as a buzzer, beeper or steady tone that plays (e.g., through a speaker configured with control body 104) when a calculated steeping time has elapsed.

In another embodiment, the tea-to-liquid ratio may be selected by the user, wherein circuitry of timer 100 (e.g., processor 506, FIG. 7) incorporates the user selected tea-to-liquid ratio into steep time calculations.

FIG. 3A shows exemplary abbreviations for tea types that may be displayed on display area 110 implemented as five 16 segment displays. An exemplary 16 segment display 111 is shown in FIG. 3B. FIGS. 3A and 3B are best viewed together with the following description.

In the example of FIG. 3A, five 16 segment displays 111 are utilized to display each of tea type abbreviations “WHITE,” “CHINA,” “JASMN,” “CHIA,” “GOOLN,” “POOCH,” “BAOZH,” “GREEN,” “JAPAN,” “BLACK,” “DRJL,” “JADEO,” “BOOLN,” “FRUIT,” “EARLG,” “HERBL,” “PUEHT” and “ROOTT”. These abbreviations respectively stand for white, Chinese, jasmine, chia, green Oolong, Pouchong, Baozhong, green, Japanese, black, Darjeeling, jade oolong, black oolong, fruit, earl grey, herbal, pueht and root teas. Some of these tea types are also shown in menu 114 of FIG. 4. In an embodiment, tea timer 100 is programmed with twenty different tea types and allows selection of three to eight tea strength levels (represented by strength indicator icon 118).

FIG. 4A is a schematic front view of control body 104 of tea timer 100, FIG. 1A. Green tea is selected on display 112, e.g., from pop-up, pull-down or otherwise scrollable menu 114 (FIG. 4B) of tea types (19 types shown in FIG. 4B; more may be available as indicated by the bottom ellipsis). Time/temperature display area 120 shows two minutes of remaining brew time. Display area 120 may also display tea/water temperature, as shown in box 132 of FIG. 4C. When time is shown at display area 120 and not temperature, C/F icon 126 is irrelevant, and reads “E.” Optionally, C/F icon 126 is not shown when time is displayed on display area 120.

Display 112 includes a temperature icon 134. Temperature icon 134 may appear on display 112 when probe 102 is measuring water/tea temperature; optionally, temperature icon 134 is always displayed when tea timer 100 is on, but flashes, illuminates or is otherwise emphasized when temperature is being measured. In one embodiment, display 112 is an LCD and icons shown on display 112 include segments listed in Table 3. Alternate display types and number of segments may be used without departing from the scope hereof.

TABLE 3
Segment Summary- Display 112

| Display Type | Number of Segments |
|---|---|
| 5 Character Tea Type Display area 110 | 80 |
| 4 Character Time/Temp Display area 120 | 28 |
| C/F icon | 2 |
| Brew Type Icons 130a-130c | 3 |
| Strength Indicator Icon 118 | 3 |
| Other | 2 |

In the embodiment shown in FIG. 4A, tea timer 100 includes a joining portion 136 for joining with probe 102. Probe 102 is removably attached to control body 104 via joining portion 136, so that probe 102 may be removed and washed after use without wetting control body 104, for example. Joining portion 136 may include a gasket 138 for enhancing fit of probe 102 with control body 104. In an embodiment, joining portion 136 includes or is connected with a hinge such that the angle between control body 104 and probe 102 is adjustable, for example to facilitate viewing of display 112 from the top, when probe 102 is in a teacup, mug or teapot.

Type button 108, FIG. 4, is show with optional text “TYPE/S” indicating type button 108 is also a start button.

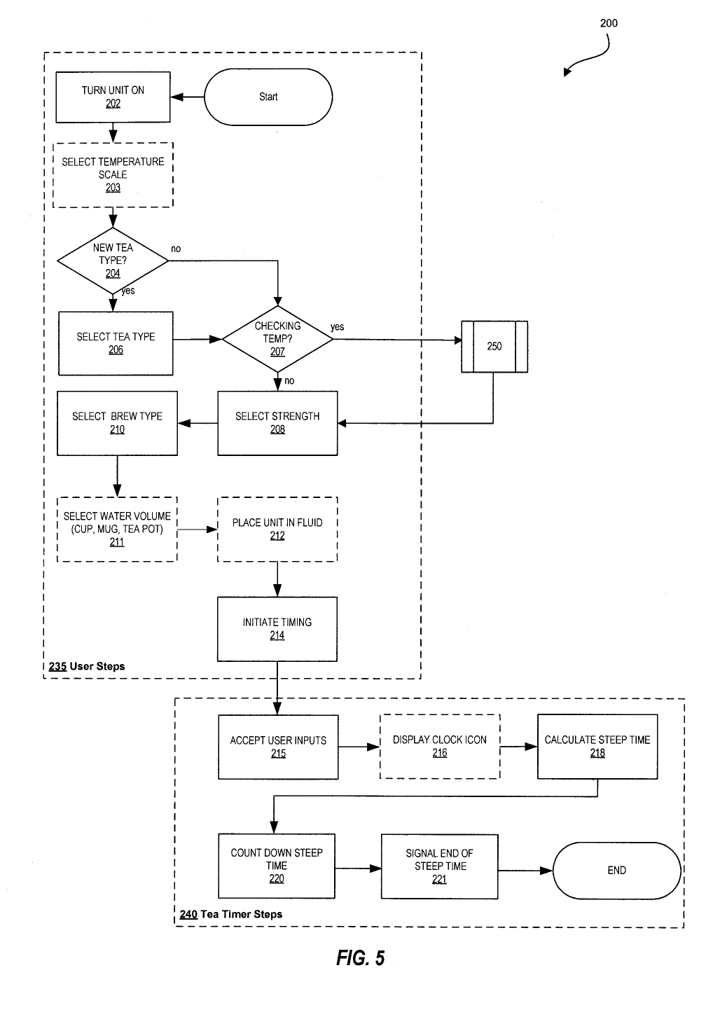

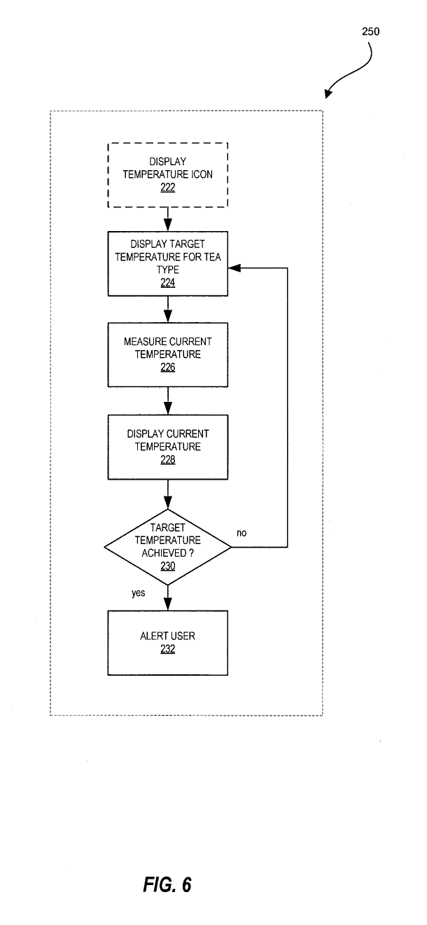

FIG. 5 is a flowchart showing a method 200 for calculating steep time. Method 200 includes a number of users steps 235 and a number of tea timer steps 240, with an optional subroutine 250 for determining an ideal water temperature for steeping a selected tea type (see FIG. 6). After turning the timer on in step 202, the user selects the temperature scale, for example, switching from Celsius to Fahrenheit or vice versa, as in step 203. If the user decides to choose a new tea type (decision 204) a tea type is selected in step 206. In one example of steps 202-206, tea timer 100 is turned on by pressing tea type button 108, FIG. 1. The temperature scale is selected by pressing mode button 122 until the desired temperature scale is indicated, and type button 108 is pressed to confirm the desired scale. If the desired tea type is not displayed by tea type display area 110, a new tea type is selected by pressing tea type button 108.

If temperature is being checked (decision 207), e.g., to determine whether a fluid is the proper temperature for steeping a selected tea type, method 200 continues with sub-routine 250, shown in FIG. 6 and described below. Otherwise, method 200 continues with step 208.

Brew strength is selected in step 208. In one example of step 208, brew strength is selected by pressing strength button 116 to display strength icons 118 with the icons arranged from left to right on the display, from weakest to strongest brew. Strength button 116 may be pressed to display icons 118 one at a time, or icons 118 may display simultaneously after a first press of button 116, and then fill in sequentially with each subsequent press of button 116. Brew type is selected in step 210. Optionally, fluid volume is selected in step 211. The timer is placed in fluid in step 212 and timing started in step 214. In one example of steps 210-214, brew type (such as loose, tea bag or tea ball) is selected by pressing mode button 122 to highlight the appropriate brew type icon 130a-130c. Optionally, fluid volume is selected by again pressing mode button 122 until the desired volume is displayed by a volume icon (not shown). If not already placed in fluid (e.g., in subroutine 250, described below), tea timer 100 is placed in tea, in step 212 (for example, probe 102 is at least partially immersed in tea brewing in a teacup, mug or teapot). Type button 108 (which may be marked “Type/S” as shown in FIG. 4) is pressed to initiate timing.

Tea timer steps 240 accept inputs entered in user steps 235. User inputs are accepted at step 215. A clock icon, e.g., clock icon 128, may display after timing initiates, in optional step 216. Step 216 is optional because the clock icon may already appear if previously displayed in subroutine 250 (described below). Tea timer 100 calculates steep time (step 218) and counts down steep time (step 220) until tea is properly brewed according to the options selected by the user in steps 203-211.

In one embodiment, tea timer 100 alternates between displaying countdown time remaining and current temperature of the fluid in which probe 102 is placed. Countdown time is for example displayed for three seconds, and current temperature for one second.

In step 218, steep time is calculated, e.g., by a microcontroller housed with control body 104, according to type of tea constants, temperature, type of brewing method, strength of tea, and/or optionally, the volume of fluid. In another aspect, the microcontroller stores in memory a steep factor for each tea type. Steep factor is the maximum number of seconds to brew a particular type of tea, and represents a strongest setting available for the tea type. Steep factor represents a ceiling to the steep time calculated in step 218. That is, the calculated steep time may not exceed the steep factor.

If a fluid volume is not selected in step 211, calculations may be made assuming a tea-to-fluid ratio of 1 tsp of tea per 8 oz. serving. Strength of tea is for example based upon a 12.5% increase of brewing time for each bar filled on an eight-bar strength icon 118, a 25% increase in brewing time for each bar filled on a four-bar strength icon 118, etc. See Table 2 for exemplary steep time calculations.

Timer 100 counts down steep time, in step 220, and signals the end of steep time, in step 221. In one example of steps 220-221, a timer configured with control body 104 counts down the time calculated in step 218, and an alarm of timer 100 signals the end of steep time. For example, an auditory alarm plays or a visual alarm (e.g., brew indicator 106, another light or a portion of display 112) illuminates steadily or intermittently.

If, in decision step 207, the fluid temperature is to be checked, method 200 continues with subroutine 250, FIG. 6. Step 222 is optional. In step 222, if included, a temperature icon is displayed. Target temperature for the tea type selected in step 206 (or the last-selected or default tea type, if no new tea type is selected, decision 204) is displayed, in step 224. Temperature is measured in step 226 and the measured temperature displayed in step 228. Until target temperature is achieved, current temperature and target temperature may be alternately displayed. Once target temperature is achieved (decision 230), the user is alerted, in step 232.

In one example of steps 222-232, probe 102 of tea timer 100 is placed, at least in part, in a teapot, mug or teacup containing hot water. Upon at least partial immersion of probe 102 in hot water, temperature icon 134 appears on display 112. Alternately, as described above, clock icon 128 appears on display 112 when type button 108 is pressed to initiate timing (i.e., when a user adds tea to the immersing fluid).

Target temperature for the selected tea type and current temperature alternately appear on display 112, for example, as shown in box 132, FIG. 4C. Tea timer 100 for example displays target temperature for three seconds, and current fluid temperature for one second. It will be appreciated that other time intervals may be used without departing from the scope hereof.

Once target temperature is achieved, the user is alerted via a visual or auditory alarm, such as a tone, beeper, buzzer, steady light, flashing light or flashing icon. For example, brew indicator 106 or another light mounted with control body 104 illuminates steadily or intermittently to alert a user that the desired temperature has been achieved. Alternately, an audible tone is played through a speaker configured with control body 104.

Upon completion of subroutine 250, method 200 recommences at step 208 (selection of brew strength, described above). At any point within method 200, the unit (tea timer 100) may be turned off, for example, by pressing and holding type button 108 for a predetermined interval, e.g., for three seconds.

FIG. 7 illustrates exemplary circuitry 300 of tea timer 100, FIG. 1. LCD display 302 for example represents display 112. A microcontroller 304 includes a processor 306 in communication with each of an analog to digital converter (ADC) 308, a memory 310, an LCD controller 312. Processor 306, ADC 308, memory 310, and LCD controller 312 may be implemented separately without departing from the scope hereof. Furthermore, additional components such as a digital to analog converter (DAC) and a digital signal processor, among others, may be included without departing from the scope hereof.

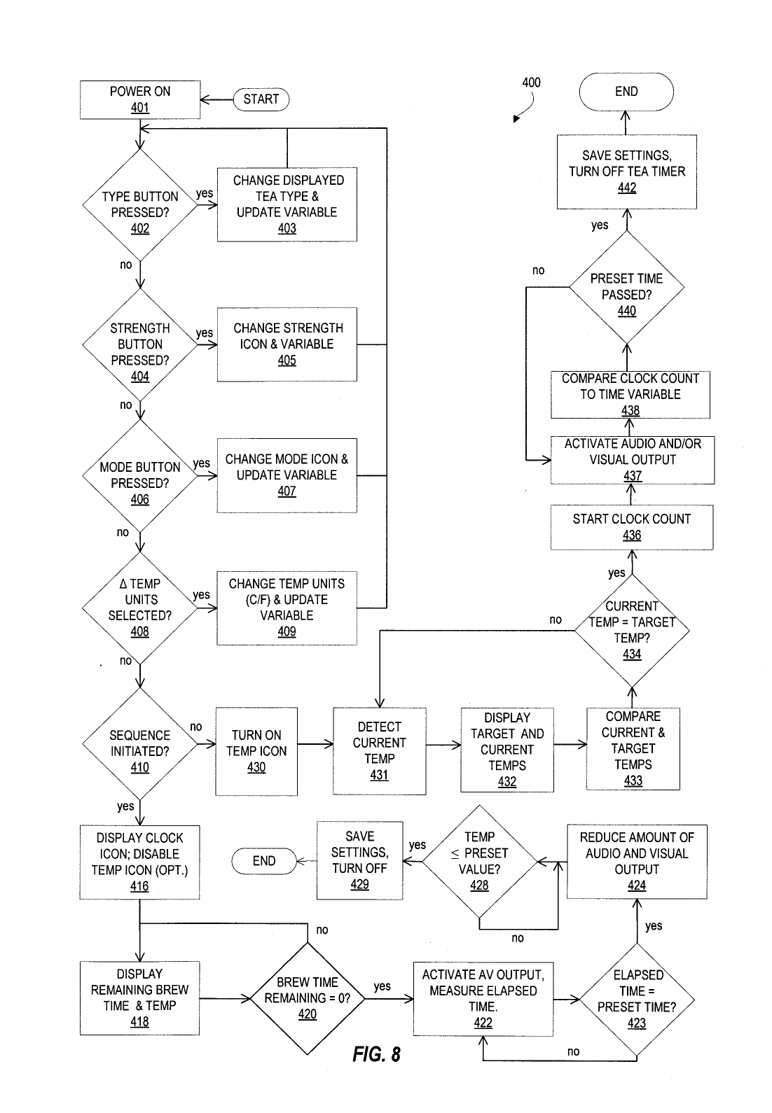

Processor 306 outputs display data to LCD display 302 via LCD controller 312. Processor 306 receives input from a temperature measuring component 318 (e.g., a thermocouple or thermistor associated with probe 102, or an IR sensor) via a voltage amplifier 320 and analog to digital converter (ADC) 308. Voltage amplifier 320 may be used to boost temperature signals from component 318 as desired or needed. Analog to digital converter (ADC) 308 converts an analog signal from voltage amplifier 320 to a digital signal processible by processor 306. A button package 316 supports tea type/S button 108, strength button 116 and mode button 122, described above, as inputs to processor 306. Memory 310 stores data, such as the most recent user selections chosen via button package 316 (examples of which are the type of tea, strength setting, C/F temperature scale and brewing mode). Memory 310 also stores an array of tea types selectable via type/S button 108, and variables for steep time calculations (e.g., steep temperatures, STF and T factor) for the array. See, e.g., Table 2, above. Data and variables of memory 310 are for example stored in software 311 (variables and data are not shown in memory 310 or software 511, for clarity of illustration). Operational logic of a method 400, FIG. 8, may also be stored as program instructions in software 311.

Component 318 may represent a thermocouple or thermistor described with respect to probe 102 of FIGS. 1 and 2, for determining a temperature of fluid (i.e., water or tea) in a teacup, mug or tea pot. Processor 306, running software 311, receives input from button package 316 and component 318, calculates steep time based on the input and on variables stored in memory 310 and outputs data to LCD display 302 (e.g., brewing time elapsed or remaining, target temperature, current temperature and other display data). Upon completion of steep time, and under control of processor 306, display 302 illuminates or flashes, or brew indicator 322, for example an LED, (corresponding to brew indicator 106, FIG. 1), to signal the end of steep time.

Optionally, processor 306 drives an amplifier 314 and a speaker 317 to generate auditory alarms/alerts, such as when remaining steep time equals zero, or when a target water or tea temperature is indicated via temperature measuring component 318, in cooperation with an optional voltage amplifier 320 and ADC 308. Voltage amplifier 320 may be included to boost voltages output by temperature sensing component 318 to a range suitable for input to ADC 308. Amplifier 314 for example may be included to boost audio signals output from processor 306 to drive speaker 317.

Circuitry 300 may be powered by a battery 321 (connections not shown for clarity of illustration).

Although shown as an LCD display, it will be appreciated that display 302 may be implemented as another type of display, such as an LED display or a capacitive touch screen, and configured to operate with circuitry 300. In an embodiment, display 302 and buttons 108, 116 and 122 are implemented as elements on a capacitive touch screen display. It will also be appreciated that circuitry 300 may include more or fewer inputs and output to increase or decrease functionality of circuitry 300 while maintaining novel aspects.

FIG. 8 is a flowchart illustrating one exemplary method 400 implemented by microcontroller 304 of circuitry 300 of tea timer 100. To maintain illustrative clarity, a power down process has not been shown but may be initiated at any point in method 400, for example, by pressing and holding type button 108 for five seconds.

In step 401, the tea timer powers on. In one example of tea timer powering on, processor 306 (FIG. 7) is woken from a sleep (low power) mode by pressing of a button (e.g., button 108). Upon waking, processor 306 restores previously saved settings and variables, for example, last selected tea type, temperature scale, tea strength, and brew type.

In decision steps 402, 404 and 406 method 400 determines if type, strength and mode buttons are pressed, respectively. In decision step 408, method 400 determines if a change of temperature units is selected. If the type button is pressed in step 402, the displayed tea type is changed and associated tea type variables are updated (step 403). Method 400 then returns to decision step 402. If the type button is not pressed (decision 402), method 400 determines whether the strength button is pressed, in decision 404. In one example, pressing the type/start button to power the unit on in step 401 will not advance tea type. The type/start button must be pressed an additional time (decision 402) to advance and change tea type, as in step 403. If it is determined that the strength button is pressed in step 404, the strength icon is changed and the associated variables updated according to the new strength (step 405). Method 400 then returns to decision step 402.

If the strength button is not pressed (decision 404), a determination is made as to whether the mode button is depressed, in decision 406. If so, the tea timer changes the brewing mode icon and updates variables associated with the newly displayed mode (step 407), then method 400 returns to step 402; otherwise, method 400 continues with decision step 408. If method 400 determines that a change of temperature units is selected in decision 408, the tea timer changes the units of the displayed temperature in step 409, and then returns to step 402. Computational variables associated with the newly displayed temperature scale may also be updated with step 409. If no change of temperature units is selected (decision 408), method 400 continues with step 410.

In one example of steps 402-409, processor 306 detects the depression of type button 108, signaling processor 306 to display, on LCD display 302, the next tea type from scrollable menu 114 and to update associated tea type variables stored in memory 310. Processor 306 then detects the depression of strength button 116, signaling processor 306 to indicate an increase in the brew strength by “filling” the next bar on strength indicator icons 118 (FIG. 4) on display 302, 112 and to update associated strength variables stored in memory 310. Upon detecting the depression of mode button 122, processor 306 “empties” one brew type icon, e.g., icon 130a, “fills” the selected brew type icon, e.g., icon 130b, and updates associated variables stored in memory 310. Processor 306 then detects a button pressing sequence (e.g., holding strength button 116 for three seconds) indicating a change in temperature units, signaling processor 306 to change the displayed C/F icon 126 and update associated variables stored in memory 310.

In decision step 410, method 400 determines if a brewing sequence is initiated (e.g., if type/S button 108 is pressed for three seconds). If method 400 determines that a brewing sequence is not initiated, method 400 performs the following steps: turns on a temperature icon (step 430), detects the current temperature of a fluid (step 431), displays a target temperature and current temperature (step 432) compares the current temperature to the target temperature (step 433) and determines it the current temperature is equal to the target temperature (decision step 434). If, in decision step 434, it is determined that the current temperature is equal to the target temperature, method 400 starts a timer or clock count, at step 436. Otherwise method 400 returns to step 431.

In one example of steps 430-434, processor 306 “fills” temperature icon 134 (FIG. 4) on display 112, 302 and determines (via probe 102 (FIG. 1), component 318 (FIG. 7), voltage amplifier 320 (FIG. 7) and ADC 308 (FIG. 7)), the current temperature of a fluid, and then records the current temperature in memory 310. Processor 306 displays the target temperature and current temperature on display 112, 302, compares the target temperature and current temperature and determines if the current temperature is equal to the target temperature.

A clock count is started, in step 436, and an auditory and/or visual alarm activated, in step 437. Step 438 compares the clock count initiated in step 436 to a predetermined time variable. Method 400 then determines if the clock count is equal to the predetermine time variable, to determine whether a predetermined amount of time has passed (decision step 440). If method 400 determines that the clock count is equal to the predetermined time variable, method 400 saves the tea timer settings and the tea timer is powered down (step 442), ending method 400; otherwise method 400 returns to step 437.

In one example of steps 436-442, processor 306 starts a clock count to track the amount of time passed since the current fluid temperature was equal to the target temperature. Processor 306 sends an auditory signal to speaker 317 via amplifier 314 and a visual signal to LCD display 302 and brew indicator 322. Processor 306 then compares the clock count to a predetermined time (e.g., 30 seconds) stored in memory 310. Determining that the clock count is equal to the predetermined time variable, processor 306 saves settings (e.g., tea type, brew strength, brew type, etc.) in memory 310 and powers down circuitry 300.

In decision step 410, if a brew sequence is initiated, method 400 continues with step 416 and displays a clock icon and optionally disables a temperature icon. In one example, holding type button 108 for 3 seconds starts the brewing sequence. Upon starting the brewing sequence, method 400 displays a clock icon and optionally disables the temperature icon (step 416), displays the brew time remaining and the current temperature (step 418) and determines if the brew time remaining is equal to zero (decision step 420). If the brew time remaining is equal to zero, method 400 activates an audio and/or visual alarm (abbreviated as “AV output” in FIG. 8 for economy of space) and tracks an elapsed time (step 422); otherwise method 400 returns to step 418. In one example of steps 416-422, processor 306 turns on clock icon 128, displays brew time remaining and the current temperature on LCD display 302 and checks the brew time remaining until the brew time remaining is equal to zero. When the brew time remaining is equal to zero, processor 306 sends an audio signal to speaker 317 via amplifier 314 and a visual signal to LCD display 112, 302 via LCD controller 312 and to brew indicator 106, 322. Processor 306 also starts a clock count to track the time elapsed since the brew time remaining reached zero (given the “yes” result at decision 420).

Method 400 then determines if the elapsed time is equal to a preset or predetermined time value (decision step 423). If the elapsed time is equal to the predetermined time value, method 400 reduces the amount of audio and/or visual output (step 424), then continues with decision 428; otherwise method 400 returns to step 422. In one example of steps 423-424, processor 306 compares an elapsed time since the remaining brew time reached zero to a predetermined time value (e.g., 30 seconds) stored in memory 310. When the two time values are equal, processor 306 turns off the audio signal sent to speaker 317 and the visual signal sent to brew indicator 106, 322.

Method 400 then determines if the fluid temperature is below or equal to a predetermined or preset value (decision step 428). When the fluid temperature is below or equals the predetermined value, method 400 saves tea timer settings and turns off the tea timer (step 429), ending method 400. In one example of steps 428-429, processor 306 determines the temperature of a fluid via probe 102, thermocouple 318, voltage amplifier 320 and ADC 308. Processor 306 then compares the determined temperature to a predetermined temperature value (e.g., 130 degrees Fahrenheit) stored in memory 310. When processor 306 determines that the determined temperatures is equal to the predetermined temperature value, processor 306 saves settings (e.g., tea type, brew strength, brew type, etc.) in memory 310 and powers down circuitry 300. Step 428 repeats until measured temperature is equal to or below the predetermined value.

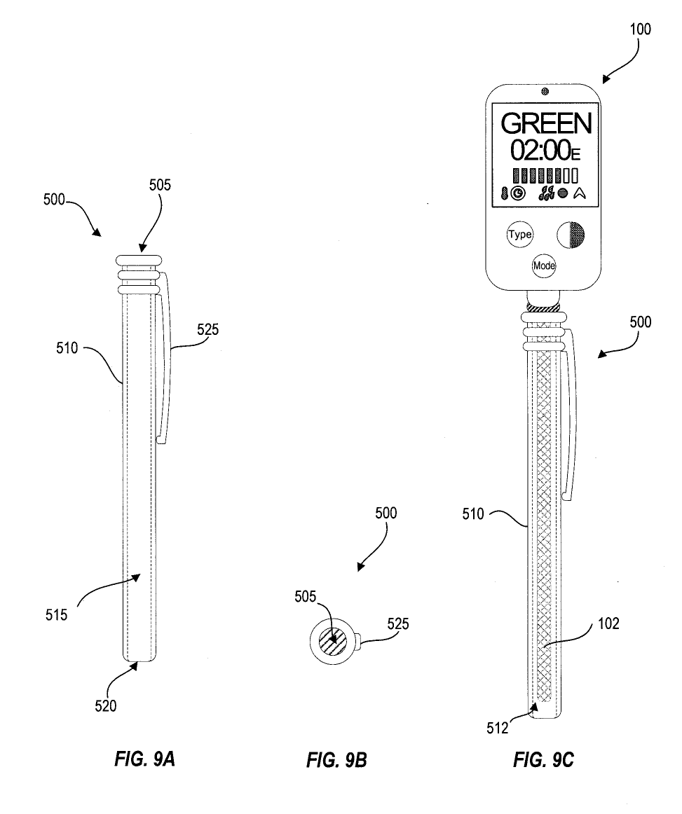

FIG. 9A shows an exemplary holder 500 for supporting a tea timer, such as timer 100, within a fluid vessel (e.g., a tea cup, tea pot or mug). FIG. 9B shows a top view of holder 500. FIG. 9C shows holder 500 configured with the tea timer 100 of FIG. 1. FIGS. 9A-9C are best viewed in combination with the following description.

Holder 500 includes a cylindrical body 510 having an outer wall and an inner wall. The inner wall of body 510 forms a through hole or cavity 515 for accepting timer 100 at a top opening 505 and fluid at a bottom opening 520. The inner wall of body 510 has a larger diameter than probe 102. When holder 500 fits with timer 100, as in FIG. 9C, the difference in diameters forms a circumferential space 512 between the inner wall of body 510 and the probe 102. Space 512 accepts fluid, thereby bathing probe 102 in the fluid (e.g., filling the space between the probe 102 and inner wall of body 510) when holder 500 supports tea timer 100 in a fluid-filled vessel. A clip 525 is configured with or mounted to circumferential body 510 such that holder 500 may be removably attached to a side, rim or wall of a fluid vessel. When holder 500 supports timer 100 (similar to FIG. 9C) and is secured to the inside of a fluid-filled vessel, probe 102 of timer 100 can accurately measure the temperature of the fluid.

It will be understood that certain changes may be made in the above systems and methods without departing from the scope hereof; thus, it is intended that all matter contained in the above description or shown in the accompanying drawings be interpreted as illustrative and not in a limiting sense. It is also to be understood that the following claims are to cover generic and specific features described herein, and all statements of the scope of the invention which, as a matter of language, might be said to fall there between.

What is claimed is:

1. A tea timer, comprising:
a temperature measuring component for measuring temperature of a fluid; and
a control body with circuitry for determining tea steeping time according to fluid temperature measured by the temperature measuring component.

2. Tea timer of claim 1, further comprising a display for displaying the determined steeping time.

3. Tea timer of claim 1, further comprising a user interface having inputs for entering a tea type and one or both of a tea strength and a brew type.

4. Tea timer of claim 3, wherein the circuitry determines tea steeping time as a function of the fluid temperature, the tea type and one or both of the tea strength and the brew type.

5. Tea timer of claim 4, the circuitry limiting the tea steeping time to a number of seconds less than or equal to a pre-programmed maximum steeping time for the tea type.

6. Tea timer of claim 4, further comprising a timer for counting down the determined tea steeping time.

7. Tea timer of claim 6, further comprising one or both of an auditory alarm and a visual alarm, for signaling the end of the tea steeping time.

8. Tea timer of claim 1, the temperature measuring component configured with a probe, and further comprising a holder for supporting the temperature measuring component in a fluid vessel, the holder comprising:
a circumferential body having a top opening, a bottom opening, an external wall and an internal wall wherein the internal wall defines a cavity for accepting (a) the temperature measuring component via the top opening, and (b) the fluid at the bottom opening; and
a clip for attaching the holder to a side or rim of the fluid vessel.

9. Tea timer of claim 8, wherein the internal wall of the circumferential body has a diameter larger that the diameter of the temperature measuring component, such that the probe is bathed in the fluid accepted at the bottom opening, when the vessel holds fluid and when the holder supports the tea timer in the fluid.

10. Tea timer of claim 1, the temperature measuring component selected from the group of a thermistor configured with a probe, a thermocouple configured with a probe, an infrared thermometer and an optical temperature measuring component.

11. A tea timer, comprising:
a temperature measuring component for measuring temperature of a fluid;
a user interface for entering a tea type and one or both of a tea strength and brew type;
a microcontroller for calculating tea steeping time according to fluid temperature measured by the temperature measuring component, tea type and one or both of tea strength and brew type;
a timer for counting down the calculated tea steeping time, and
an alarm for signaling when the calculated tea steeping time has elapsed.

12. Tea timer of claim 11, the temperature measuring component selected from the group of a thermistor configured with a probe, a thermocouple configured with a probe, a thermometer configured with a probe, a thermistor configured with a probe and an infrared thermometer.

13. Method for determining tea steeping time, comprising:
accepting a tea type via a user interface;
measuring temperature of a fluid for brewing tea;
accepting one or both of a tea strength and a brew type via the user interface; and
processing the tea type, the fluid temperature and one or both of the tea strength and brew type, to determine tea steeping time.

14. Method of claim 13, further comprising displaying the steeping time.

15. Method of claim 13, further comprising displaying the fluid temperature.

16. Method of claim 15, further comprising alternately displaying the fluid temperature and the steeping time.

17. Method of claim 13, further comprising counting down the determined tea steeping time.

18. Method of claim 17, further comprising initiating an alarm upon termination of the determined tea steeping time.

19. Method of claim 13, wherein processing comprises processing the tea type, fluid temperature and one or both of the tea strength and the brew type with data in a memory, to determine the steeping time.

20. Method of claim 13, wherein processing comprises processing the tea type, fluid temperature and one or both of the tea strength and the brew type with a steep factor representing a maximum steeping time for the tea type, wherein the determined steeping time does not exceed the steep factor.
